(19) United States
(12) Patent Application Publication
(10) Pub. No.: US 2005/0028637 A1
(43) Pub. Date: Feb. 10, 2005

(54) Handle cover promotions system and method

(76) Inventor: Sarah Nicole Coty, Kansas City, MO (US)

Correspondence Address: Mark E. Brown;Chase Law Firm, L.C., Suite 130, 4400 College Boulevard, Overland Park, KS, 66211, US

(21) Appl. No.: 10/634,502

(22) Filed: Aug. 5, 2003

(51) Int. Cl. B62K 21/12

(52) U.S. Cl. 74/551.9

(57) ABSTRACT

A handle cover promotions system includes multiple, generally tubular shopping cart handle covers, which can be nested and removably placed in a dispenser adapted for installation at an entrance to a retail place of business where shopping carts are available. The handle covers have coupons printed thereon and are manufactured from recyclable material. A method of promoting retail sales of goods and/or services includes the steps of nesting said handle covers into stacks, placing same in said dispenser, extracting individual handle covers for use on respective shopping cart handles and using the coupons printed thereon in connection with retail transactions at said retail business.

### BACKGROUND OF THE INVENTION

The present invention relates generally to handle covers and, more particularly, to a shopping cart handle cover promotions system and method of advertising utilizing the system including a point of sales dispenser for the shopping cart handle cover.

Use of metal or plastic shopping carts in supermarkets or luggage carts in airports, for example, is widespread. The cart handle is seldom, if ever, cleaned allowing dirt and germs to be passed from one user to the next. Additionally, when children are placed in a shopping cart, they may place their hands on the shopping cart handle and then place their hands in their mouth or place their mouths directly on the handle. Another problem is the potential for injuring small children in a shopping cart if the child's head or mouth impacts the shopping cart handle.

Various devices have been proposed to address these problems including padding or covering the handle bar of shopping carts with plastic or foam covers. Other devices have been proposed which incorporate coupons or advertising on the handle cover. Often these handles are cumbersome to store and present disposal problems.

### SUMMARY OF THE INVENTION

The present invention provides a handle cover promotions system and promotions method including a cover for a shopping cart handle which provides sanitary and physical protection to the user and provides an advertising space for a sponsor. The handle covers nest together for convenient storage and dispensing and are recyclable and/or biodegradable. A divided dispenser is provide to organize and dispense the covers and may be located at the point of sales.

### BRIEF DESCRIPTION OF THE DRAWINGS

FIG. 1 is a perspective, enlarged view of the shopping cart handle cover of the present invention mounted on a shopping cart handle.

FIG. 2 is a perspective view of the shopping cart handle cover of FIG. 1 shown with a shopping cart.

FIG. 3 is a perspective view of a point of sale dispenser and storage container for a plurality of nested shopping cart handle covers of the present invention.

FIG. 4 is a perspective view of the shopping cart handle cover of FIG. 1.

FIG. 5 is a cross-sectional view of the shopping cart handle cover of FIG. 1.

FIG. 6 is a front elevational view of the shopping cart handle cover of FIG. 1 shown partially mounted.

FIG. 7 is a front elevational view of the shopping cart handle cover of FIG. 6 shown mounted.

### DETAILED DESCRIPTION

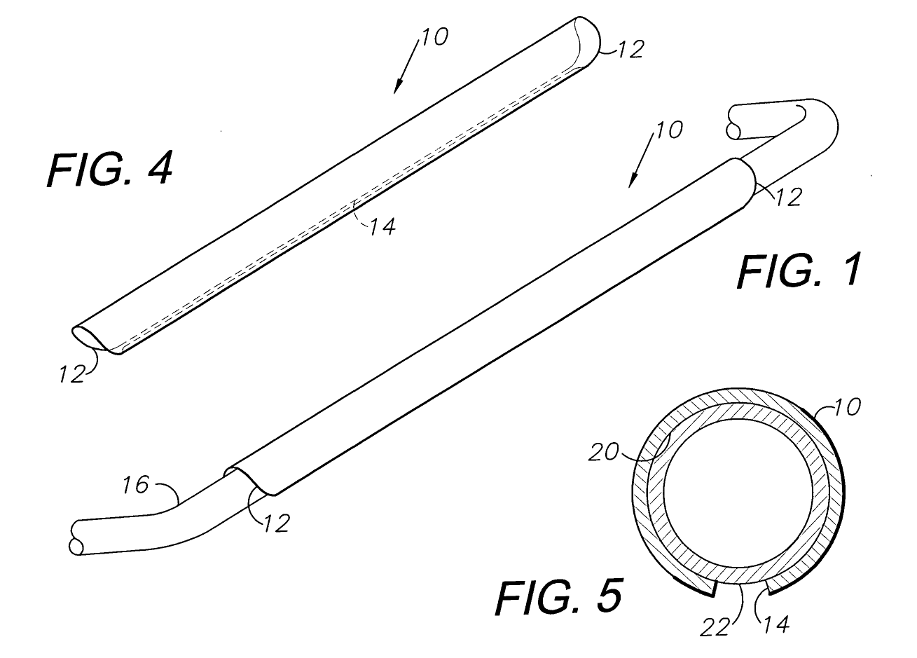

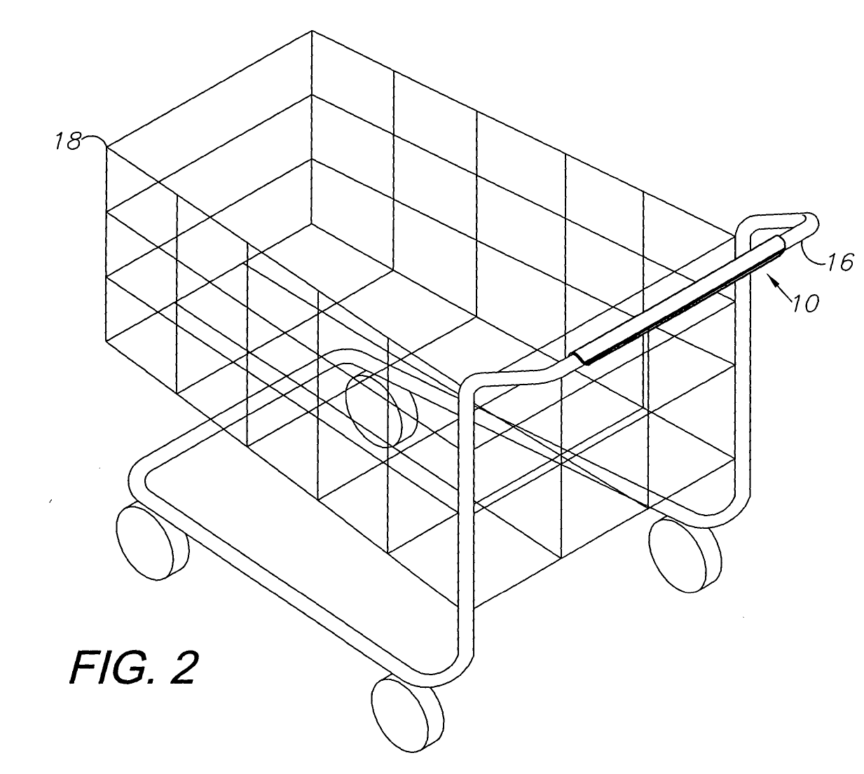

Referring to FIGS. 1, 2, 4 and 5, the shopping cart handle cover of the present invention is generally indicated by reference numeral 10. Handle cover 10 is a generally elongated hollow tube with curved ends 12 and a longitudinal slit 14 running the length of the cover 10. The cover 10 is sized to fit around the handle 16 of a shopping cart 18. Although handle cover 10 is shown used with a shopping cart 18 it is not intended to be so limited. Handle cover 10 may be used with a wide variety of carts or handles including hospital carts, food service carts, luggage carts in airports, and athletic equipment handles, for example.

Handle cover 10 may be constructed of cardboard or other paper product or other material which is disposable, recyclable and biodegradable. The handle cover 10 may be formed or rolled into a tube and cut to a length of approximately 18 inches. Handle cover 10 may be trimmed to any length. The inner diameter 20 of handle cover 10 is slightly less than the outer diameter 22 of handle 16 to ensure a snug fit around handle 16. A cushioning material (not shown) may also be included in the inner diameter 20 of cover 10.

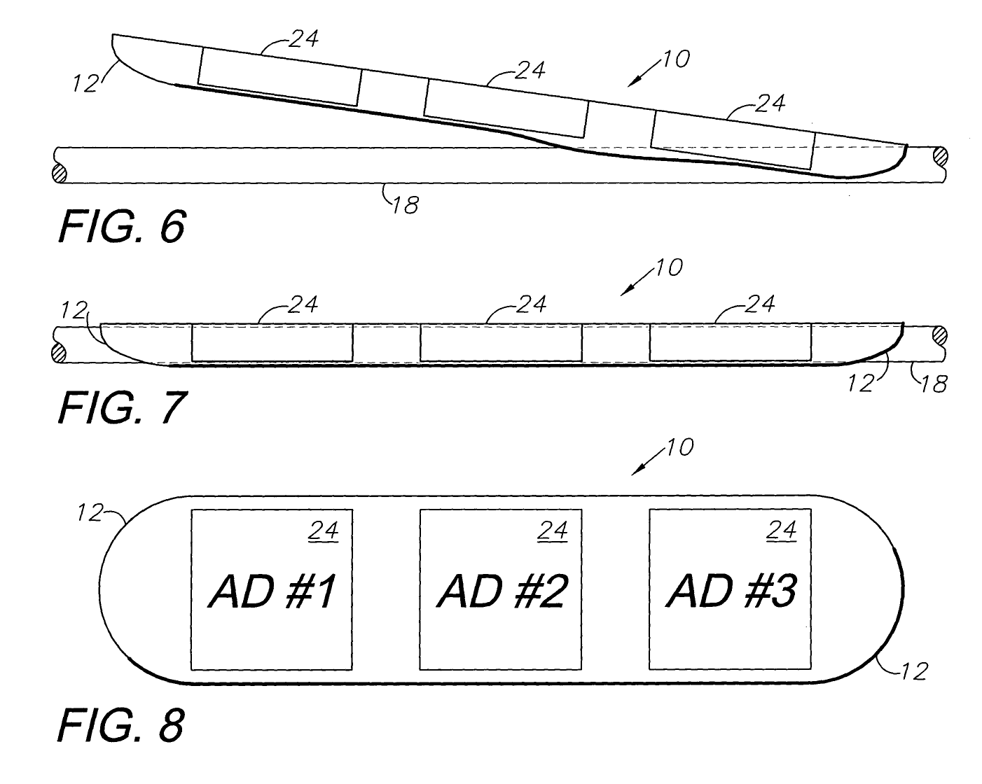

Referring to FIGS. 6-8, handle cover 10 is shaped to easily fit around handle 16. The rounded ends 12 of handle cover 10 allows the cover 10 to spread along slit 14 to fit around handle 16. The handle cover 10 has a spring memory to retain its shape after it has been fitted around a handle 16.

Indicia 24 such as advertisements or coupons may be printed on or attached to handle cover 10. The advertisements or coupons 24 may be used to enhance a user to purchase the products of a sponsoring merchant or product manufacturer. Coupons may be releasable so that a shopper may redeem the coupon upon purchase of the corresponding product. The coupons or ads 24 may wrap around the handle cover 10 and handle 18.

As shown in FIG. 8, the handle cover 10 may be cut from a flat piece of material in a generally elongated shape with curved ends 12. The handle cover 10 may then be formed into a tube for use with a handle.

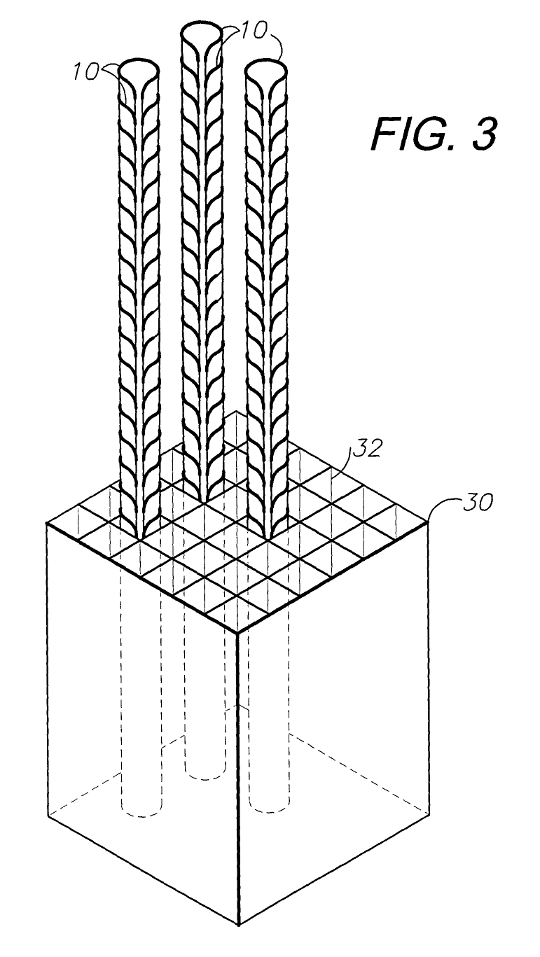

Referring to FIG. 3, a point of sale dispenser 30 is illustrated. A plurality of handle covers 10 nested together may be inserted into the openings 32 in dispenser 30. Dispenser 30 may be free standing or may be mounted to a wall so that the cover 10 may be free standing or may be mounted to a wall so that the cover 10 may be dispensed either vertically or horizontally. The dispenser 30 may be shaped to fit in a variety of locations.

When a customer or shopper enters a retail store which uses shopping carts or baskets, for example, the shopping carts are near the front entrance of the store. The customer may be directed to the shopping carts which may be used to carry merchandise selected by the customer. A point of sale dispenser 30 may be located with the shopping carts to provide ready access to the handle covers 10. Additional advertising may be place on the sides of dispenser 30 to attract customers. A customer may remove one of the handle covers 10 and place it on a shopping cart handle 16. Advertising or coupons 24 may be used to suggest certain products to the customer. Once the cart has been used and returned to the store by the customer or by a store employee, the handle cover 10 may be removed and discarded.

It is to be understood that while certain embodiments and/or aspects of the invention have been shown and described, the invention is not limited thereto and encompasses various other embodiments and aspects.

1. A handle cover for a cart having a handle, said handle cover comprising:
a generally tubular, hollow handle cover having curved ends and a longitudinal slit extending the length of the handle cover, said handle cover adapted to fit around the handle of a cart,
indicia printed on or attached to an outside surface of said handle cover, said indicia including commercial advertising or other promotional material, and
said handle cover adapted to be nested with a plurality of said handle covers for storage and distribution.

2. The handle cover as set forth in claim 1 wherein said handle cover is made of cardboard.

3. The handle cover as set forth in claim 1 wherein said handle cover is made of a heavy paper.

4. The handle cover as set forth in claim 1 wherein said indicia includes at least two advertisements.

5. The handle as claimed in claim 1 wherein said indicia includes at least two coupons.

6. The handle cover as claimed in claim 1 further comprising a padding material secured to an inside surface of said handle cover.

7. A point of sale dispenser for dispensing handle covers for use with carts having a handle, said point of sale dispenser comprising:
a container having a plurality of cavities, each of said cavities adapted to receive at least one handle cover, said container having at least three sides, and at least one of said sides of said container having indicia for identifying said handle covers.

8. The point of sale dispenser as set forth in claim 7 wherein each of said cavities is adapted to receive and dispense a plurality of nested handle covers.

9. The point of sale dispenser as set forth in claim 7 wherein said dispenser is cardboard.

10. The point of sale dispenser as set forth in claim 7 wherein said dispenser is free standing.

11. The point of sale dispenser as set forth in claim 7 wherein said dispenser is attached to a wall or other structure for support.

12. A retail merchandising method for promoting goods and/or services and covering shopping cart handles at a retail business with a public entrance and shopping carts located in proximity thereto, which comprises steps of:
providing a point of sale dispenser with four sides, a closed bottom, an open top and an interior open at said top;
providing said dispenser with multiple dividers positioned within said dispenser interior and forming a divider grid therein comprising multiple rows and columns of individual, vertically-oriented receivers each extending vertically from said dispenser bottom to said dispenser top and being open thereat;
promoting goods and/or services available at said retail business with said dispenser by providing promotional indicia on at least one of said dispenser sides;
providing a plurality of handle covers each having a generally tubular configuration with curved opposite ends, a passage extending longitudinally between and open at said ends and a slot extending longitudinally between and open at said ends with said passage being open at said slot;
fabricating said handle covers from disposable, recyclable paper or cardboard stock;
applying to said handle covers multiple coupons corresponding to goods and/or services currently available for sale at said retail business pursuant to a discounted sale or promotion of same;
nesting multiple covers into multiple cover stacks by inserting respective cover ends into adjacent cover passages;
placing said cover stacks in said dispenser receivers with said covers extending upwardly above said stack upper end;
installing said dispenser with said cover stacks placed therein in proximity to an entrance to said retail business whereat shopping carts are available to the customers;
extracting said handle covers from said nested stacks of same and from said dispenser;
placing a first end of a respective handle cover over a shopping cart handle whereby said slot expands adjacent to said one end;
receiving a part of said shopping cart handle in a part of said passage adjacent to said one end thereof;
pressing said handle cover onto said shopping cart handle by expanding said slot and passing said shopping cart handle therethrough into said passage;
conducting a retail transaction at said retail business utilizing at least one of said coupons;
disposing said handle covers; and
recycling said handle covers.

13. The method according claim 12, which includes additional step of printing said coupons on said cover in a partially-circling relationship.

14. The method according to claim 12, which includes the additional steps of printing said coupons separately and releasably adhering same to said cover, peeling said coupons from said cover and using same in connection with a retail transaction.
